(19) United States
(12) Patent Application Publication
(10) Pub. No.: US 2006/0262295 A1
(43) Pub. Date: Nov. 23, 2006

(54) Apparatus and method for inspecting a wafer

(75) Inventors: Henning Backhauss, Wetzlar (DE); Wolfgang Sulik, Asslar (DE); Michael Heiden, Woelfersheim (DE); Albert Kreh, Solms (DE)

Correspondence Address: HOUSTON ELISEEVA, 4 MILITIA DRIVE, SUITE 4, LEXINGTON, MA, 02421, US

(73) Assignee: Vistec Semiconductor Systems GmbH, Wetzlar (DE)

(21) Appl. No.: 11/405,922

(22) Filed: Apr. 18, 2006

(30) Foreign Application Priority Data
May 20, 2005 (DE) 10 2005 023 243.4

(51) Int. Cl. G01N 21/88

(52) U.S. Cl. 356/237.2

(57) ABSTRACT

The present invention relates to an apparatus and a method for inspecting a wafer, comprising an illumination means for illuminating the surface of a wafer, an imaging means for optically imaging the surface of the wafer with at least one camera having an imaging area, a movement means for a relative movement between the imaging area and the surface of the wafer, and an evaluation means for evaluating the wafer, wherein the imaging means comprises two cameras focused on the same imaging area.

### RELATED APPLICATIONS

This application claims priority to German application serial number DE 10 2005 023 243.4 on May 20, 2005, which is incorporated herein by reference in its entirety.

### FIELD OF THE INVENTION

The present invention relates to a method for inspecting the surface of a wafer wherein the wafer is evaluated by evaluating the image of the wafer.

### BACKGROUND OF THE INVENTION

An apparatus of the above type is known from DE 103 30 006. In this apparatus an imaging area is illuminated on the wafer and imaged by a camera.

The state of the art has a drawback in that the pixel resolution is limited when a color camera is used. Color cameras with high-pixel resolutions are disproportionately expensive.

It is therefore an object of the present invention to develop an apparatus and a method of the initially described type in such a way that color information and high resolution structure information can be obtained in a cost-effective way.

This object is achieved both by the apparatus defined in claim 1 and the method defined in claim 10. Advantageous embodiments of the invention are defined in the respective dependent claims.

### SUMMARY OF THE INVENTION

According to the present invention the object is achieved in an apparatus for inspecting a wafer, comprising an illumination means for illuminating the surface of a wafer, an imaging means for optically imaging the surface of the wafer having at least one camera with an imaging area, a movement means for a relative movement between the imaging area and the surface of the wafer, and an evaluation means for evaluating the wafer, by providing that the imaging means comprises two cameras focused on the same imaging area.

In the practical application it has been shown that two cameras, each specializing in its own application, are more cost-effective than one camera specializing in a plurality of requirements.

It is preferably provided that the imaging means comprises cameras of differing resolution.

This is advantageous in that a very high resolution image can be obtained with one camera, while other specialized requirements can be fulfilled using another, lower-resolution camera.

It is suitably provided that the imaging means comprises a color camera and a monochromatic camera.

Suitably the imaging means comprises a color camera with a low resolution and a monochromatic camera with a high resolution.

The monochromatic camera can be a common black and white camera or a camera specialized in a spectral range. The camera can be a matrix or linear array camera, in particular a CCD matrix camera.

The advantage in this arrangement is that color information is usually needed for detecting layer thicknesses. For this purpose it is sufficient to have color information in low resolution. Particle defects will not usually be read from a color image. These particle defects can usually be seen in the image as brightness fluctuations in the form of dots. This is why a monochromatic image is sufficient for their detection. However, this monochromatic image should have a particularly high resolution depending on the size of the defects to be detected.

Apart from layer thicknesses, the following errors can mainly be detected with the aid of a color image: focusing errors in the stepper illumination and hot spots, i.e. a distortion of the wafer due to particles under the wafer during illumination.

Otherwise the color information is not usually necessary for high resolution inspection tasks. Typical errors only reflected in the color of the image can usually be detected in large areas and with low resolution. Small defects can readily be detected in a high-resolution black and white image. To keep the amounts of data to be processed as small as possible and in order to save storage space and processing time it is therefore advantageous to take a high-resolution black and white image and a low-resolution color image of the wafer.

For the monochromatic image a dark-field illumination can be chosen in which dot defects appear as bright points on a dark background. Bright-field illumination can be chosen for the color image in particular, which will show thickness variations, such as of a photoresist layer, as an interference image.

It is also conceivable to have a combined bright and dark-field illumination for detecting dot defects.

According to an embodiment of the invention it is provided that the imaging means comprises an image allocation optics which allocates the image of the image area to the two cameras.

According to a preferred embodiment of the invention it is provided that the imaging means comprises a beam splitting mirror as an allocation optics.

A beam splitting mirror is a low-cost approach to direct the image of the imaging area toward the two cameras. It is provided for the imaging means to comprise an image allocation optics allocating a spectral range of the imaging area to the monochromatic camera.

This is advantageous in that precisely one portion R, G, or B from the RGB spectrum can be allocated to the monochromatic camera. As a result, two portions of the RGB spectrum are present in the image of the color camera while the remaining portion is present in the image of the monochromatic camera. The complete color image can therefore be calculated from a combination of the two images.

Advantageously, the illumination for the monochromatic camera can be a dark-field illumination scanning across the imaging area and adapted in its spectral range to the spectral range of the monochromatic camera. In particular the spectral range of the dark-field illumination can correspond to the spectral range allocated to the monochromatic camera by the imaging optics.

According to one embodiment it is provided that the imaging means comprises an image allocation optics having a spectral selection means allocating a variable spectral range of the imaging area to the monochromatic camera.

Suitably the imaging means comprises an image allocation optics, and the image allocation optics comprises the movement means.

The relative movement of the movement means can either be implemented by an arrangement associated with the support of the wafer or by varying the imaging beam path, in particular by using mobile mirrors or else by using a transportation means for the entire imaging means.

According to the present invention the originally mentioned object is further achieved in a method for optically imaging a wafer by the following process steps: illuminating the surface of a wafer, imaging an imaging area of a wafer with a first camera, imaging the same imaging area of the wafer with a second camera having a different resolution, varying the surface of the wafer covered by the imaging area, evaluating the camera images.

Suitably the imaging is carried out with the two cameras simultaneously.

Suitably the variation of the imaging area is a displacement movement.

Preferably the imaging area corresponds to a stepper illumination area.

A stepper illumination area also called a stepper area window (SAW) comprises a portion, one or more dies or semiconductor elements on the wafer.

By displacing the imaging area from one stepper illumination area to the next stepper illumination area, the wafer can be scanned in a meandering form in the well known fashion.

It is particularly advantageous that by displacing and repeated execution of the method the wafer is scanned.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The invention will be described in the following in more detail with reference to schematic views of an exemplary embodiment. The same elements are indicated by the same reference numerals in the individual figures, wherein:

FIG. 1 is a schematic overview of the arrangements of the apparatus according to the present invention,

FIG. 2 is a top plan view of a wafer with inscribed imaging areas.

### DETAILED DESCRIPTION OF THE PREFERRED EMBODIMENTS

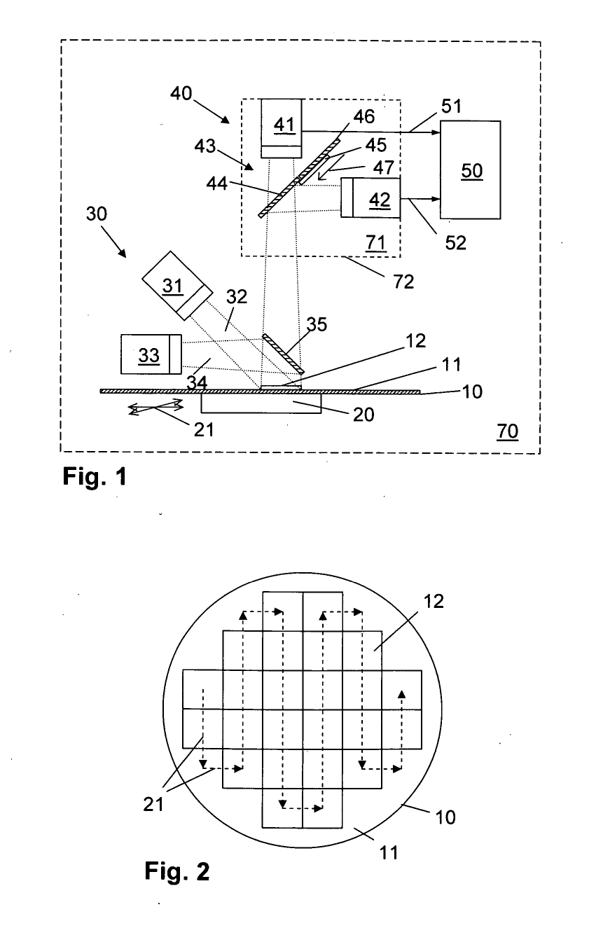

FIG. 1, in a schematic representation, shows the apparatus of the present invention comprising the movement means 20, the illumination means 30, the imaging means 40 and the evaluation means 50.

The wafer 10 is supported by a movement means 20 which can transport the wafer in the movement direction 21. An imaging area 12 is shown on the wafer surface 11. This imaging area 12 is illuminated by the illumination means 30. The illumination means 30 comprises a dark-field light source 31 and a bright-field light source 33, as well as a beam splitting mirror 35. The dark-field light source 31, with its illumination beam 32, illuminates the imaging area 12 at an angle. The light beam 34 of the bright-field light source 33 is projected by a beam splitting mirror 35 in parallel to the imaging beam path.

The imaging means 40 comprises a color camera 41, a black and white camera 42 and an image allocation optics 43. The image allocation optics 43 consists of a first beam splitting mirror 44 and a second beam splitting mirror 46 able to be displaced in the direction of arrow 47 to the location of the first beam splitting mirror 44 via a spectral range selection means 45. The first beam splitting mirror 44 couples the imaging beam path of the black and white camera 42 co-linearly into the imaging beam path of the color camera 41 and also focuses it vertically onto the imaging area 12. The beam splitting mirror 44 can be a 50:50 beam splitting mirror or a dichroic beam splitting mirror for selectively allocating a predetermined spectral range to the black and white camera 42. The spectral range selection means 45 can replace the first beam splitting mirror 44 by the beam splitting mirror 46. Beam splitting mirror 46 selects a different spectral range than beam splitting mirror 44 to be projected onto the black and white camera 42. The color camera 41, the black and white camera 42, and the image allocation optics 43 are combined in a module 71. Module 71 comprises a support 72 on which the color camera 41 and the black and white camera 42 are mounted. The image allocation optics 43 is also mounted on carrier 72. The movement means 20, the illumination means 30, the imaging means 40, and an evaluation means 50 are arranged in a wafer inspection assembly 70. The evaluation means 50 is connected with the color camera via a data line 51 and with the black and white camera via a data line 52.

Any monochromatic camera can be used as the black and white camera 42. Advantageously the spectral range directed towards the monochromatic camera 42 by the beam splitting mirror 44 is adapted to the monochromatic camera 42, just like the spectral range of the dark-field light source 31 is adapted to the spectral range of the monochromatic camera 42.

The dark-field light source 31 is in accordance with the detection of defects. The defects are intended to be detected by the higher resolution black and white camera 42. This is why the spectral range of the dark-field illumination 31 is adapted to the spectral range of the beam splitting mirror 44 or the monochromatic camera 42. The bright-field illumination 33 corresponds to the detection of layer thickness anomalies, which are detected in the color image of the color camera 41. This is why the bright-field light source 33 emits a highly broad-band spectrum, i.e. white light.

FIG. 2 shows a top plan view of a wafer 10 having imaging areas 12 inscribed on its wafer surface 11. The imaging areas 12 can correspond to stepper illumination areas. These illumination areas 12 are imaged in a meandering order in the well known fashion. Arrows 21 show the movement direction of the relative movement between the imaging means 40 and the wafer 10.

While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for inspecting a wafer, comprising an illumination means for illuminating the surface of a wafer, an imaging means for optically imaging the surface of the wafer with at least one camera with an imaging area, a movement means for relative movement between the imaging area and the surface of the wafer, and an evaluation means for evaluating the wafer, characterized in that the imaging means comprises two cameras focused on the same imaging area.

2. The apparatus according to claim 1, characterized in that the imaging means comprises cameras of different resolution.

3. The apparatus according to claim 1, characterized in that the imaging means comprises a color camera and a monochromatic camera.

4. The apparatus according to claim 1, characterized in that the imaging means comprises a color camera having low resolution and a monochromatic camera having high resolution.

5. The apparatus according to claim 1, characterized in that the imaging means comprises an image allocation optics, which allocates the image of the imaging area to the two cameras.

6. The apparatus according to claim 1, characterized in that the imaging means comprises a beam splitting mirror as the image allocation optics.

7. The apparatus according to claim 1, characterized in that the imaging means comprises an image allocation optics, which allocates a spectral range of the imaging area to the monochromatic camera.

8. The apparatus according to claim 1, characterized in that the imaging means comprises an image allocation optics having a spectral range selection means, which allocates a variable spectral range of the imaging area to the monochromatic camera.

9. The apparatus according to claim 1, characterized in that the imaging means comprises an image allocation optics, and the image allocation optics comprises the movement means.

10. A method for optically imaging a wafer, characterized by the steps of:
illuminating the surface of a wafer,
imaging an imaging area of the wafer with the first camera,
imaging the same imaging area of the wafer with a second camera of different resolution,
changing the surface of the wafer covered by the imaging area,
evaluating the camera images.

11. The method according to claim 10, characterized in that the imaging is carried out with the two cameras simultaneously.

12. The method according to claim 10, characterized in that the changing of the imaging area is by displacement.

13. The method according to claim 10, characterized in that the imaging area corresponds to a stepper illumination area.

14. The method according to claim 13, characterized in that by the displacement and by repeated execution of the method the wafer is scanned.
